(19) United States
(12) Patent Application Publication
(10) Pub. No.: US 2013/0174930 A1
(43) Pub. Date: Jul. 11, 2013

(54) APPARATUS AND METHODS FOR A HYDROXY GAS ASSISTED COMBUSTION ENGINE

(71) Applicants: Roberto Lara Arroyo, (US); Luis Gutierrez Murguia, (US)

(72) Inventors: Roberto Lara Arroyo, (US); Luis Gutierrez Murguia, (US)

(21) Appl. No.: 13/549,455

(22) Filed: Jul. 14, 2012

Related U.S. Application Data
(60) Provisional application No. 61/508,047, filed on Jul. 14, 2011.

(51) Int. Cl. F15C 1/04

(52) U.S. Cl. CPC F15C 1/04
USPC 137/807

(57) ABSTRACT

The present invention describes methods and apparatus for generating a controlled amount of Hydroxy Gas “HHO Gas” and supplying the HHO Gas upon demand to a combustion engine, in an effective manner that is conducive to increasing the efficiency of combustion engine and significantly reducing the amount harmful gas emitted to the environment. The efficiency and constant generation of controlled amounts of HHO Gas capabilities due to the inclusion of an electrolyte solution and concentric coil designs.

### RELATED APPLICATIONS

This application claims priority to U.S. Provisional Patent Application Ser. No. 61/508,047, filed on Jul. 14, 2011, and entitled “APPARATUS AND METHODS FOR HYDROGEN ASSISTED COMBUSTION ENGINE”, the contents which are relied upon and incorporated by reference.

### FIELD OF INVENTION

The present invention relates to methods and apparatus of generating Hydroxy Gas (“HHO Gas”) and providing said HHO Gas on demand to a combustion engine, such as a compression or spark ignition automobile or truck engine.

### BACKGROUND OF THE INVENTION

It is known that the burning of oil based fuels such as diesel and gasoline can emit gases, such as carbon monoxide and hydrocarbons which are generally considered to be polluting or harmful to the environment. Therefore it is considered to be favorable to have combustion engines that are capable of reducing the amount of polluting gases emitted during the consumption of fuels. Moreover, in the combustion engines of motor vehicles, burning less fuel is generally equated as higher miles per gallon. Other combustion engines may also include stationary machinery, generators and power tools in which, like higher miles per gallon in motor vehicles, a more efficient use of fuel power would result.

As a result, through the development of combustion engines many have provided for different methods and apparatus that provide gains in fuel efficiency, however, still greater efficiencies to decrease harmful gas emissions and further increase higher miles per gallon are desired.

One exemplary method of recent efforts to decrease an amount of oil based fuel includes mixing an oil based fuel with HHO Gas prior to combustion. The HHO Gas which is commercially available in fixed amount bottled forms. The HHO Gas can then help the fuel burn cleanly and facilitate additional power and efficiency for the combustion engine. However, these currently available methods can provide for various limitations and drawbacks, including for example, having significant amounts of bottled HHO Gas to make it bulky and dangerous in many applications for storage. As a result, additional improved methods and apparatus for making, managing and used the HHO Gas are desired.

### SUMMARY OF THE INVENTION

Accordingly, the present invention provides methods and apparatus for generating a controlled amount of Hydroxy Gas “HHO Gas” and supplying amounts of the HHO Gas upon demand to a combustion engine in an effective manner conducive to increasing the efficiency of a motor vehicle powered by the combustion engine and significantly reducing the amount harmful gas emitted to the environment.

In some aspects of the present invention, HHO Gas can be generated upon demand through the application of an electric charge. In some embodiments of the present invention, a relatively cheap, generally commercially available, non-toxic, and non-corrosive liquid or dissolved electrolyte can be utilized. The preferred embodiments in which the present invention can be implemented are internal combustion engines. For example in some preferred embodiments, the generated HHO Gas can be introduced and mixed with a gasoline or diesel fuel supply of an internal combustion engine of an automobile in a controlled manner. The mixing of the generated HHO Gas with a gasoline or diesel fuel supply in a controlled manner consequently resulting in a significant reduction in emission of contaminating gases into the atmosphere, greater energy consumption efficiency for the generation of HHO Gas, and greater miles per gallon fuel efficiency.

In some aspects of the present invention, the concentric coil design forms comprised of anode and cathode arrangements are used to significantly increase surface area of the anode and cathode and increase the efficiency of the apparatus by lowering the energy required to generate the HHO Gas.

Additionally, some embodiments of the present invention can include a temperature sensor, such as a thermometer, to measure the temperature of the apparatus and control the production of HHO Gas based on the measured temperature through loop control, since the temperature of the apparatus can be proportional to the amount of HHO Gas being produced. Some embodiments may additionally or alternatively include a current sensor or a pressure sensor for the same purpose.

### BRIEF DESCRIPTION OF THE DRAWINGS

As presented herein, various embodiments of the present invention will be described, followed by some specific examples of various components that may be utilized to implement the embodiments. The following drawings are only exemplary embodiments of the present invention presented to facilitate the description:

FIG. 1 illustrates a block diagram flowchart of exemplary method steps that may be implemented in conjunction with apparatus of the present invention are illustrated.

FIG. 2 illustrates an exemplary concentric coil design formed from anode and cathode arrangements that may be implemented in some embodiments of the present invention.

FIGS. 3A, 3B, 3C and 3D illustrate an exemplary tank that may be used to house the concentric coils of FIG. 2 used to generate and provide HHO Gas to the fuel system of a vehicle's combustion engine in accordance with the present invention.

FIG. 4 illustrates an air intake with a gas input connection according to some embodiments of the present invention.

FIG. 5 illustrates a schematic coil designs according to some embodiments of the present invention.

FIG. 6 illustrates a graph of an optimal placement distance between electrodes.

FIG. 7 illustrates specifications of an exemplary tank for generating hydrogen.

FIG. 8A illustrates measured gas emission data from an automobile without the apparatus of the present invention in a table and corresponding graph forms.

FIG. 8B illustrates measured gas emission data from an automobile with the apparatus of the present invention in a table and corresponding graph forms.

FIG. 9 illustrates a schematic exemplary concentric coil design formed from anode and cathode arrangements that may be implemented in some embodiments of the present invention.

FIG. 10 illustrates a schematic tank design that may be used to house the concentric coils of FIG. 9 used to generate and provide HHO Gas to the fuel system of a combustion engine in accordance with the present invention.

### DETAILED DESCRIPTION OF THE INVENTION

The present invention provides methods and apparatus for providing HHO Gas to a combustion engine, or other fuel burning device according to fuel demands placed upon the combustion engine. The combustion engine which may preferably include an internal combustion engine, or diesel engine. In additional embodiments of the present invention, the apparatus can provide for the supply of HHO Gas to a fuel cell or heating device. In general, the present invention provides for improved production of HHO Gas by passing an electrical current through one or more coils formed from anode and cathode configurations according a the desired HHO Gas output. Generally the electrical current can pass through an arrangement of coils. Wherein the coils are in a conductive medium, such as the purified water and electrolytes, and maintain a constant distance between them to ensure that the breaking up of the molecules occurs in a more constant manner.

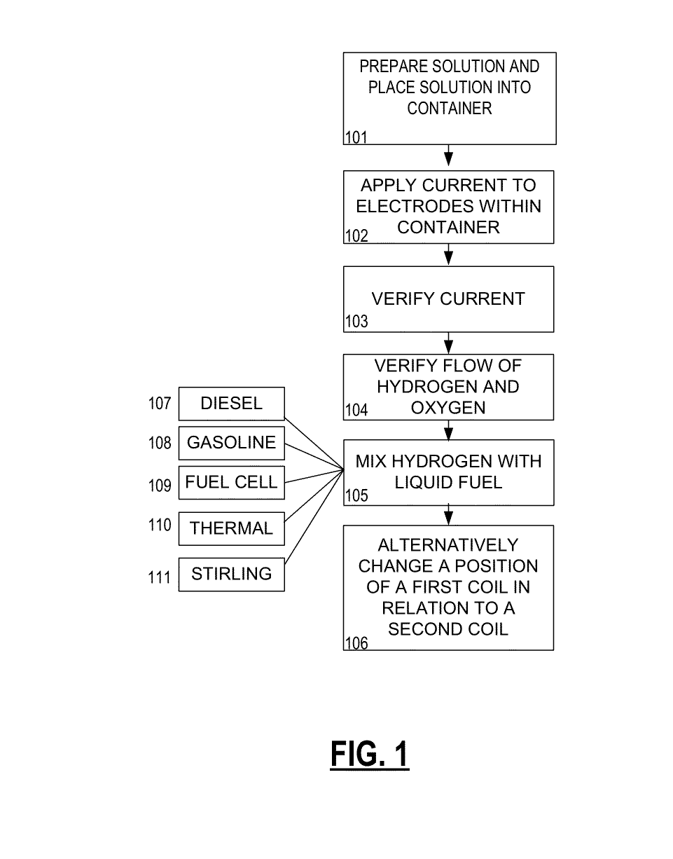

Referring now to FIG. 1, exemplary method steps that may be implemented in conjunction with apparatus of the present invention are illustrated according to some embodiments of the present invention. At 101, in embodiments where low voltage is desired for efficiency, for example below 50 Volts, it can be preferred to include an electrolyte solution which can promote the production of HHO Gas. As discussed further below, the solution can preferably include a non-corrosive mixture of acid salts, for example sodium bicarbonate, and water and it may be introduced into the container, wherein the container can also house at least one pair of a first electrode and a second electrode. For example, Table 1 below presents different exemplary tested Electrolytes, concentrations, and yields, according to some embodiments of the present invention.

TABLE 1
HHO Generation Using 70 volts.

| | | Concentration | Current | Yield |
|---|---|---|---|---|
| Electrolyte type | | (molarity) | (Amps) | (lts/hr) |
| — | — | 2 Liters of | 7.5 | 9.4 |
| | | purified H₂O. | | |
| KOH | Potassium | 0.01426M* | 52 | 65.0 |
| | Hydroxide | | | |
| NaHCO₃ | Sodium | 0.00953M* | 29 | 36.3 |
| | Bicarbonate | | | |
| NaOH | Sodium | 0.02000M* | 60 | 75.0 |
| | Hydroxide | | | |

*All refer at the purified H₂O

It will be apparent to one skilled in the art from this invention disclosure that the type of electrolyte, concentration and current are factors, among others discussed below, that are proportional to the yield and that other electrolytes and variations in current and concentrations may be used to yield different amounts of HHO Gas as appropriate for the specific application/embodiment. Consistent with and as presented in Table 1, the liquid solution can be purified water, but more preferably in some embodiments, should include an electrolyte such as sodium bicarbonate or baking soda, or preferably it may include: purified water and NaHCO₃ with a concentration from about 0.02 mol/Liter to 0.2 mol/Liter.

The at least one pair of a first electrode and a second electrode essentially comprise an anode and a cathode to begin the reduction and oxidation of the H₂O. In preferred embodiments the anode may be arranged as a coiled around the coiled cathode, although other embodiments may include a cathode coiled around an anode. Furthermore, multiple pairs of anodes and cathodes are included within the container as coils and may act in parallel or in series with each other to increase or decrease the production of HHO Gas.

At 102, a voltage is applied to the electrodes included within the container. In some embodiments, the voltage may be applied to a first pair of anodes and cathodes. However, the functioning at least one pair of anode and cathode should be at least partially submerged with the solution within the container since the solution can act as the conductive medium.

At 103, current applied flow can be verified to ensure production of HHO Gas results as desired. At 104, a presence of hydrogen and oxygen may be verified within the container, wherein the presence of hydrogen and oxygen is based upon the electrical current flowing through the at least one pair of electrode and cathode. A flow of HHO Gas may be created and transferred via a gas egress part of the container, for example, tubing or piping to an air intake of a combustion engine.

At 105, the HHO Gas may be introduced and mixed with a fuel mixture supplied to the combustion engine. At 107-110, various types of engines that may be supplied with hydrogen or both (hydrogen and oxygen) are included. Engines types include, for example, a diesel engine 107, a gasoline engine 108, a fuel cell 109, a thermal engine 110 and a Stirling engine 111. More specifically, in some embodiments the generated HHO Gas may be ported and conveyed by tubing from the container to an air intake and mixed with ambient air which may then entered into an intake manifold for supply to the combustion engine.

At 106, in some alternative embodiments, a relative positions of an anode to the cathode may be manipulated such that the surface area of the anode that is proximate to the cathode is varied. As previously mentioned, a greater surface area resulting from more coils of anode to cathode proximate to each other will result in a greater production amount of HHO Gas and a lesser area of anode to cathode coils proximate to each other will result in a lesser amount of HHO Gas produced. Moreover, other ways of manipulating surface area can include for example, arranging an anode and cathode as concentric coils and sliding one or both coils of anode and cathode in positions in relation to one another.

### Basic Electrolysis Reaction

Water can be decomposed through electrolysis for the hydrogen atoms in water to be reduced, and the oxygen atoms oxidized. The reaction is:

2H2O→2H2+O2

The oxidation state of oxygen in water is −2, and the oxidation state of hydrogen is +1. However, the oxidation state of both hydrogen and oxygen in the products is 0 (zero). Hydrogen thus gains 1 electron (2 total to form H2), and oxygen loses 2 (4 total to form O2).

So H2 can be evolved where electrons are being put into the water at the cathode. At the cathode, electrons can from the electrode into the water to reduce water:

4H2O (l)+4e−→2H2 (g)+4OH− (aq)

At the anode, the oxidation of water can occur, and electrons go into the electrode:

2H2O (l)→O2 (g)+4H+ (aq)+4e−

Therefore, O2 can be evolved at the anode, and H2 can be evolved at the cathode.
When these ions can come into contact with their respective electrodes they can either gain or lose electrons depending on their ionic charge. For example, in this case the hydrogen can gain electrons and the oxygen can lose them. In doing so, these ions balance their charges, and can thereby become electrically balanced bona fide atoms or molecules.

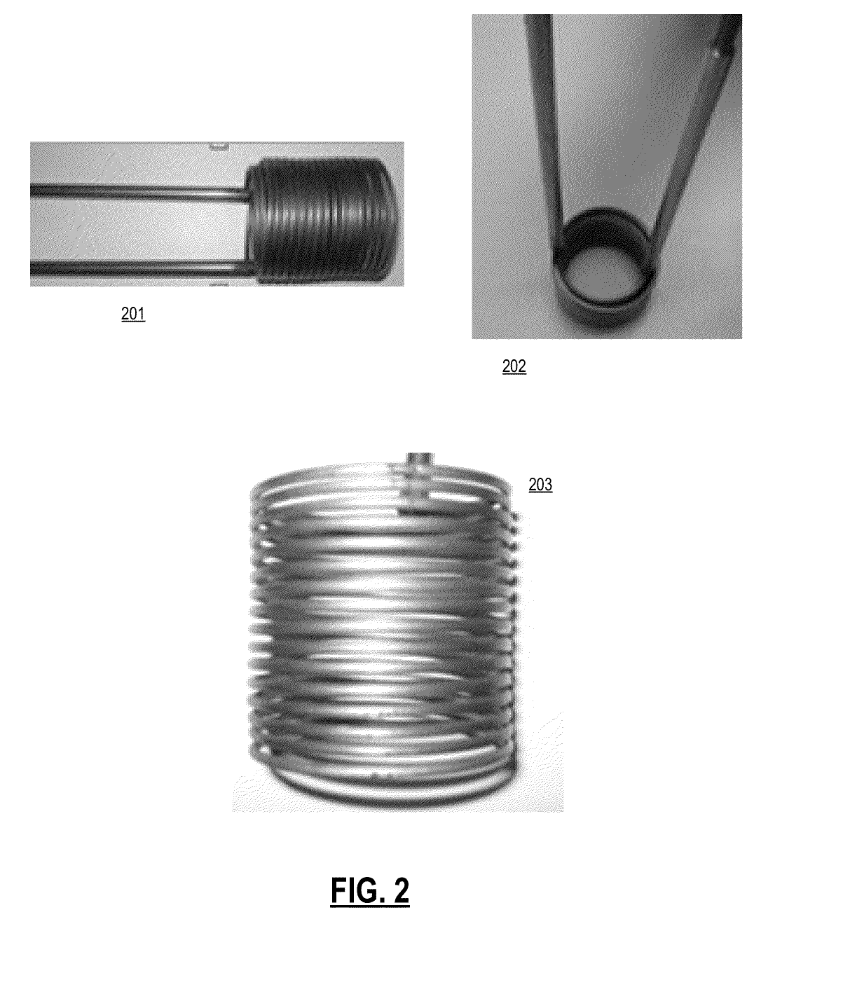

Referring now to FIG. 2, an exemplary concentric coil design formed from anode and cathode arrangements that may be implemented in some embodiments of the present invention is illustrated. Generally, each of the anode and cathode may be formed into coils and placed such the respective coils are proximate to each other, with, on, or inside one another, such that an outer coil may be arranged concentrically around an inner coil. As presented in the present exemplary embodiment, a number of coils will preferably be between 1 and 20, although other sized coils may also be used and although a theoretical number of coils is limitless, a practical number of coils will depend upon a wire used to fashion one or both of the anode and cathode, the surface area required for energy consumption efficiency, and a physical size of a container into which the anode and cathode are placed.

As depicted, the Anode and Cathode can be preferably manufactured from a non-corrosive, or corrosion resistant, conductive material, such as for example, stainless steel AISI type with a gauge of 316 L and with ⅛″ of diameter. In some embodiments, the number of “turns” that are needed can be from 17 to 34 between both the Anode and Cathode, with a separation within them of 1/16″.

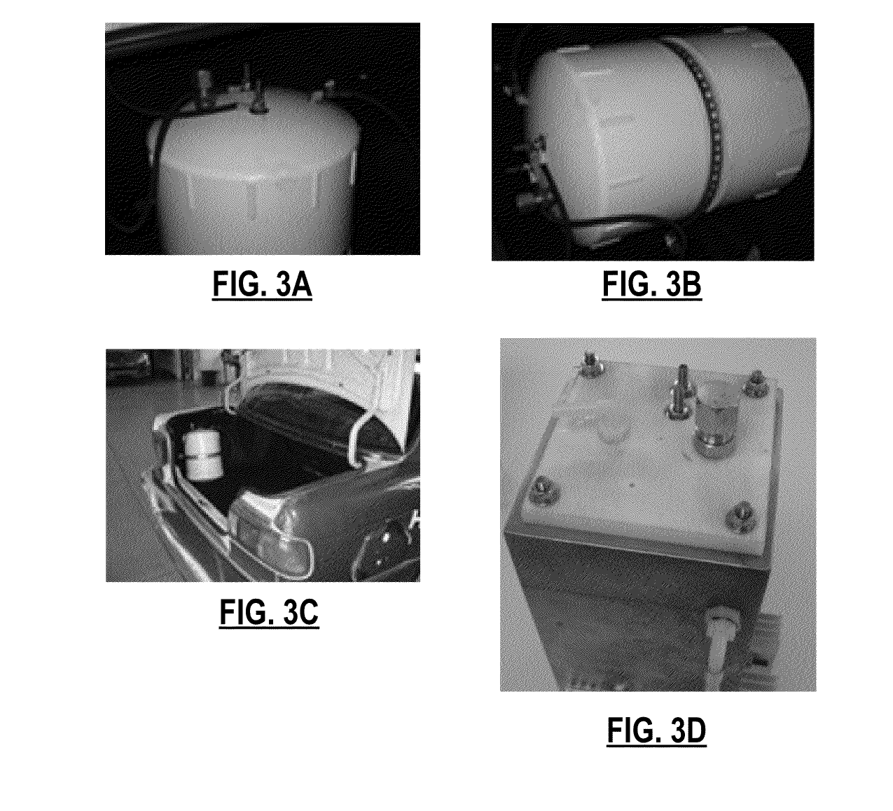

Referring now to FIG. 3A-D, containers for different embodiments of the present invention are illustrated. As depicted in FIGS. 3A-3C, the container may be manufactured from a thermoplastic. However, for temperature regulation it may be desired in some preferred embodiments, as depicted in FIG. 3D, that the container be made of stainless steel, or metal. In some embodiments, the temperature of the container may raise to an unwanted levels, for example above 60 Degrees Celsius, and as a result it may be desired that the material is one that does not contain the heat and acts as an insulator but instead one that allows the heat out of the system.

In other aspects of the container, a preferred embodiment may include the metal container with means of handling the container using parts that will not reach unmanageable temperatures for a person to handle it safely. More importantly, embodiments can also include a temperature sensor to both regulate the production of HHO Gas, as the higher the temperature of the container results in higher production of HHO Gas and the lower the temperature results in lower production of HHO Gas, and to ensure a safe temperature of the material used and surrounding environments is safe. The temperature sensor may be, for example, a thermal transducer and may send a signal to the loop control system upon reaching pre-programmed temperatures to vary the tension and current accordingly. The electronic control may be achieved through a PWM generator with pre-programmed oscillation frequencies of the water to increase the efficiency of electrolysis accordingly. Some embodiments may also include a pressure sensor, or valve, as a safety precaution, for example as an emergency shut off mechanism, where the production of HHO Gas is significant.

As depicted in FIG. 3C, the physical size of the container will be constrained according an environment in which it will be placed, such as, the size of a trunk of an automobile. However, in other uses such as an industrial use, the HHO Gas apparatus may include a container that is tens of meters high. Likewise, it may be desired to have smaller containers for applications that may warrant a tank that may be held in one hand. The container will hold both the solution and the anode and cathode coils and the size/amount of those will consequently be relative.

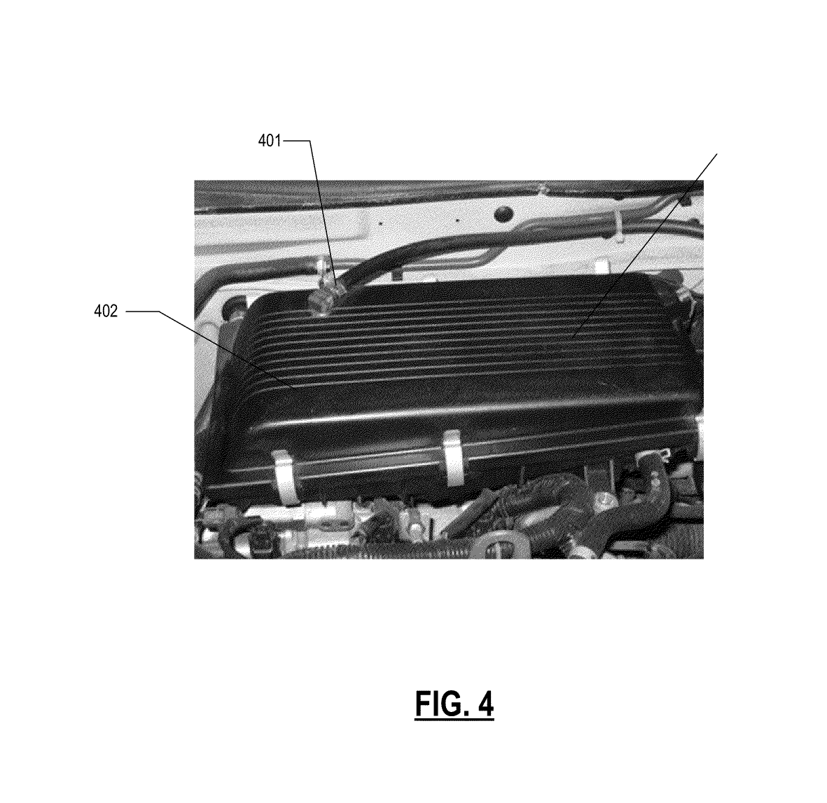

Referring now to FIG. 4, exemplary tubing 401 used for input of a flow of HHO Gas into an atmospheric intake housing 402 on an automobile combustion engine is illustrated. As illustrated, the tubing 401 may include a flexible plastic, such as, for example one or more of: a polyurethane tubing; a multi-layered composite tubing including an interior aluminum tubing lined with inner and outer layers of UV resistant polyethylene (PE); an automotive grade rubber hose.

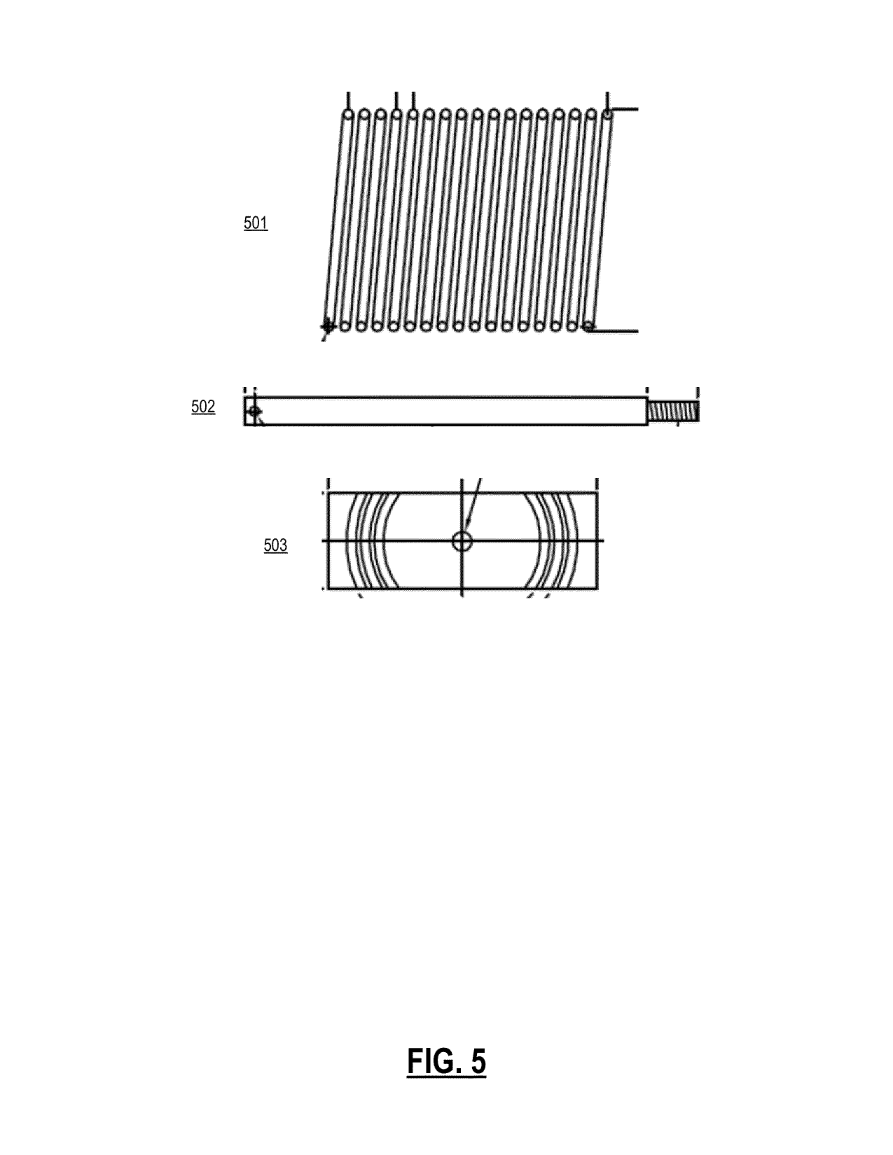

Referring now to FIG. 5, a schematic coil design for some preferred embodiments is depicted. Preferably the anodes and cathodes are formed into coils 501 which may be attached to a conductive rod 501. At 503, a schematic diagram of an exemplary configuration of a coil is depicted having the different rings of the coils being either anode or cathode accordingly.

In some exemplary embodiments the coils may include from 14 to 34 winds in each coil and a container of the present invention used in the combustion engine system of an automobile may include anywhere from 1 to 20 coils and preferably 5 coils for a compact size automobile. The greater the number of coils can provide for greater surface area and greater production of HHO Gas. However, too much production of HHO may require greater voltages, complex temperature management systems, and greater container volumes.

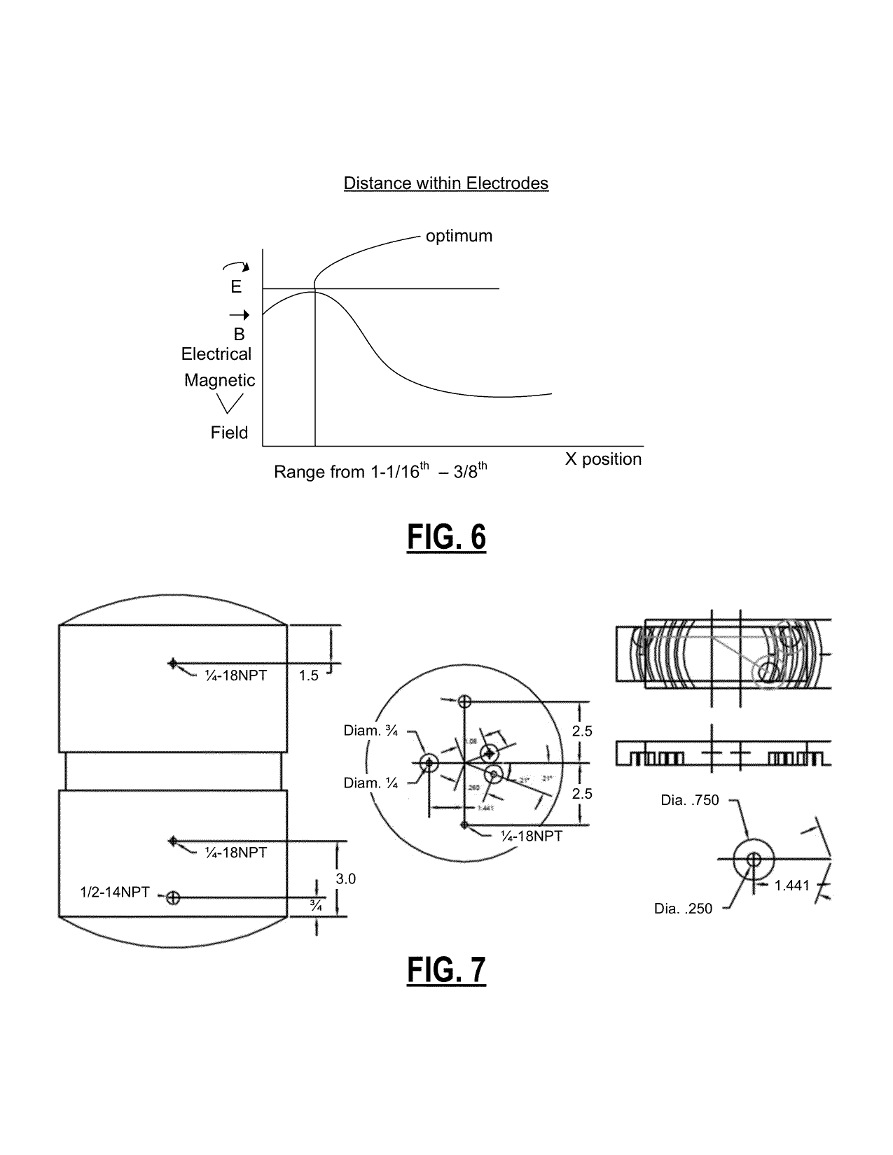

Referring now to FIG. 6, a graph illustrates a relationship between a distance between the anode and the cathode in some embodiments of the present invention. According to the graph an anode fashioned from 316 L gauge wire of stainless steel material is preferably positioned proximate to a cathode of 316 L gauge wire of stainless steel material. As illustrated, for an automobile internal combustion engine, the anode coil may optimally be positioned about 1/16th to ⅜th of an inch from a cathode coil.

In the present example relating to an apparatus for an automobile internal combustion engine, 5 coils made up of a series of cathode and anode winds in each coil can be maintained at least partially immersed in a conductive medium. Further, a constant distance between the coils and rings should be maintained to make sure that constant breaking down of water molecules can result. The constant breaking down of water molecules which can result in a more controlled production of HHO Gas and can keep a undisturbed environment for the molecules remain in the gas phase, until it enters the combustion chambers of the engine.

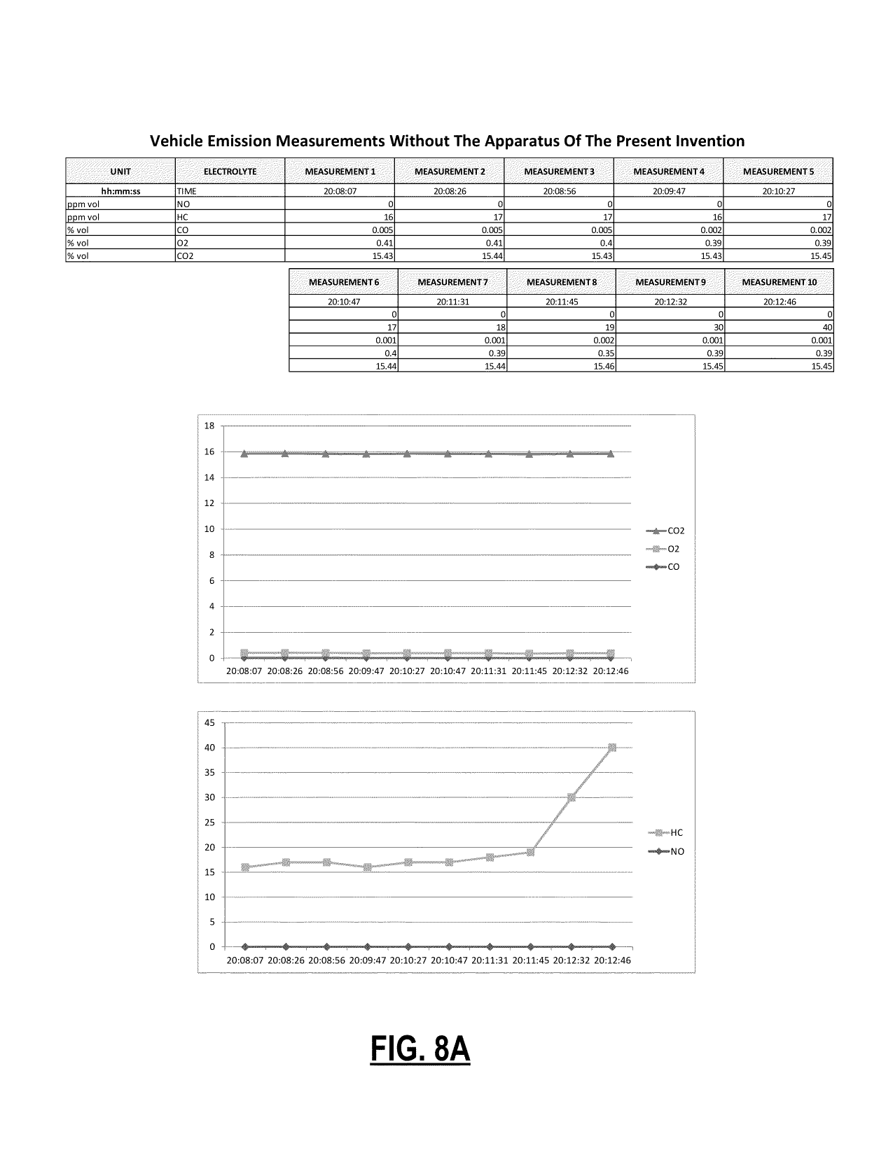

Referring now to FIG. 7, a graphical representation illustrates dimensions of a tank suitable for implementations of the present invention that may be used with an automobile internal combustion engine. In addition, consistent with FIG. 7, the coils may preferably be positioned at a lower portion of the tank when the tank is to be vertically placed. The two holes made on the sides of the container can be used to indicate the amount of liquid present in the container. The bottom hole can serve as means of draining the container in such case that the internal liquid needs to be extracted.

The container may also include a number of holes, such as, for example, three holes, which are placed so that they can hold one or both of the electrodes (anode and cathode) in a precise position, a fourth hole may serve as a way to both fill the tank with the aqueous solution and a fifth one to extract the HHO Gas from the container. The container can also include support system for the electrodes in order to maintain the electrodes in the correct and exact position.

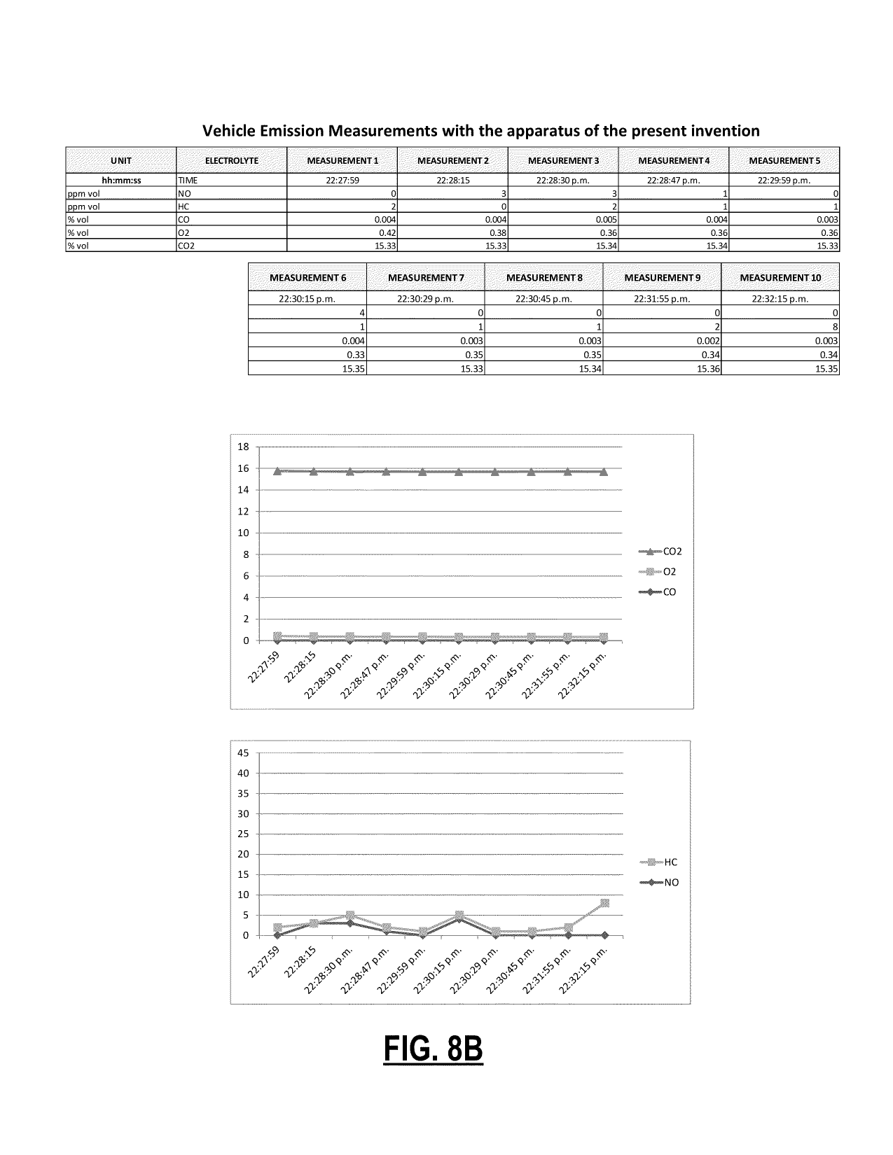

Referring now to FIG. 8A, measured gas emission data from an automobile without the apparatus of the present invention in a table and corresponding graph forms is depicted to be compared FIG. 8B depicting measured gas emission data from an automobile with the apparatus of the present invention in a table and corresponding graph forms. The depicted graphs and data related to the emissions of an internal combustion engine of medium size automobile. However, as known in the art, larger and smaller engines can have relatively proportional emissions and the emission of Hydrocarbons (“HC”) into the environment can also be significantly reduced as represented.

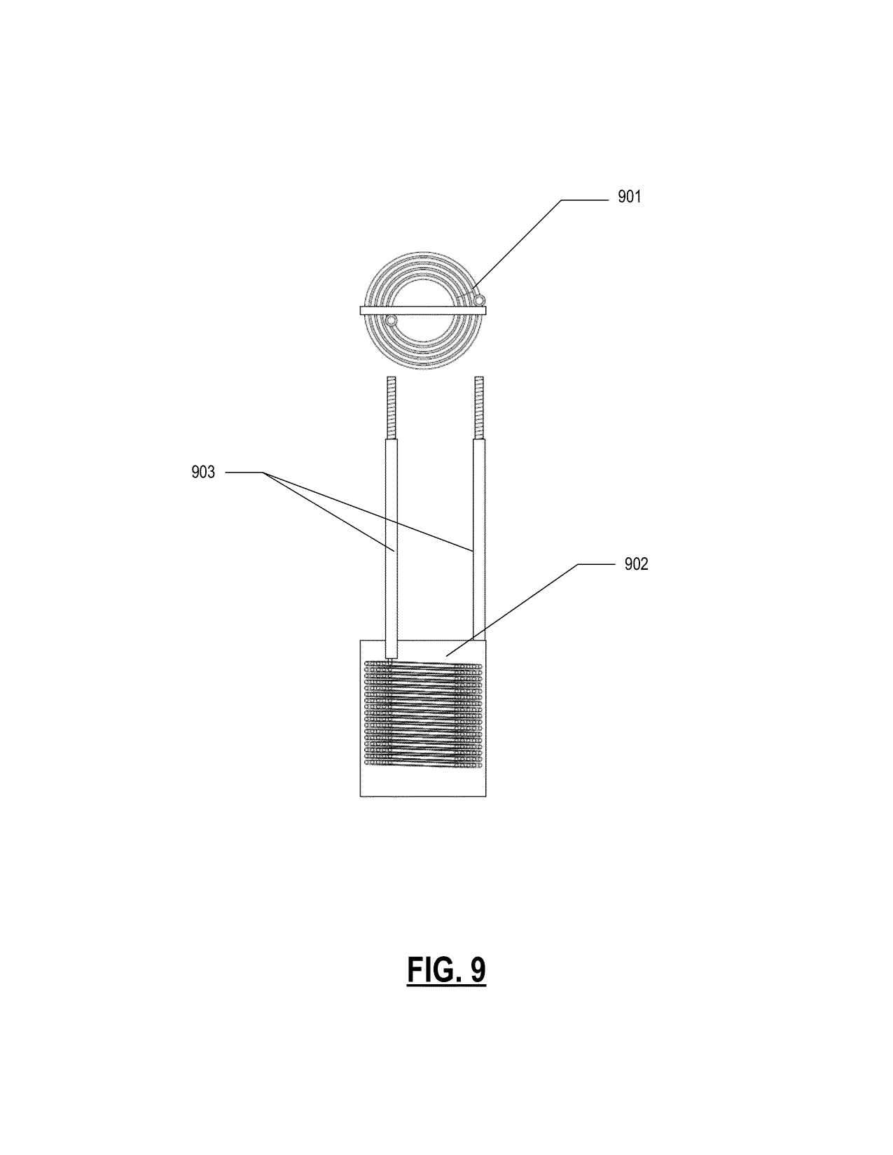

Referring now to FIG. 9, a schematic diagram of a coil design is illustrated. The concentric coil design includes 5 winds formed from anode and cathode concentric arrangements. At 901, a coil made up of five (5) winds of anode, cathode is depicted. At 902, a separator, such as for example a plate, can be included to separate and support the coils, the winds and the electrical conductors 903. The electrical conductors 903 may be, as depicted, one or more stainless steels in contact with the power source and the coils.

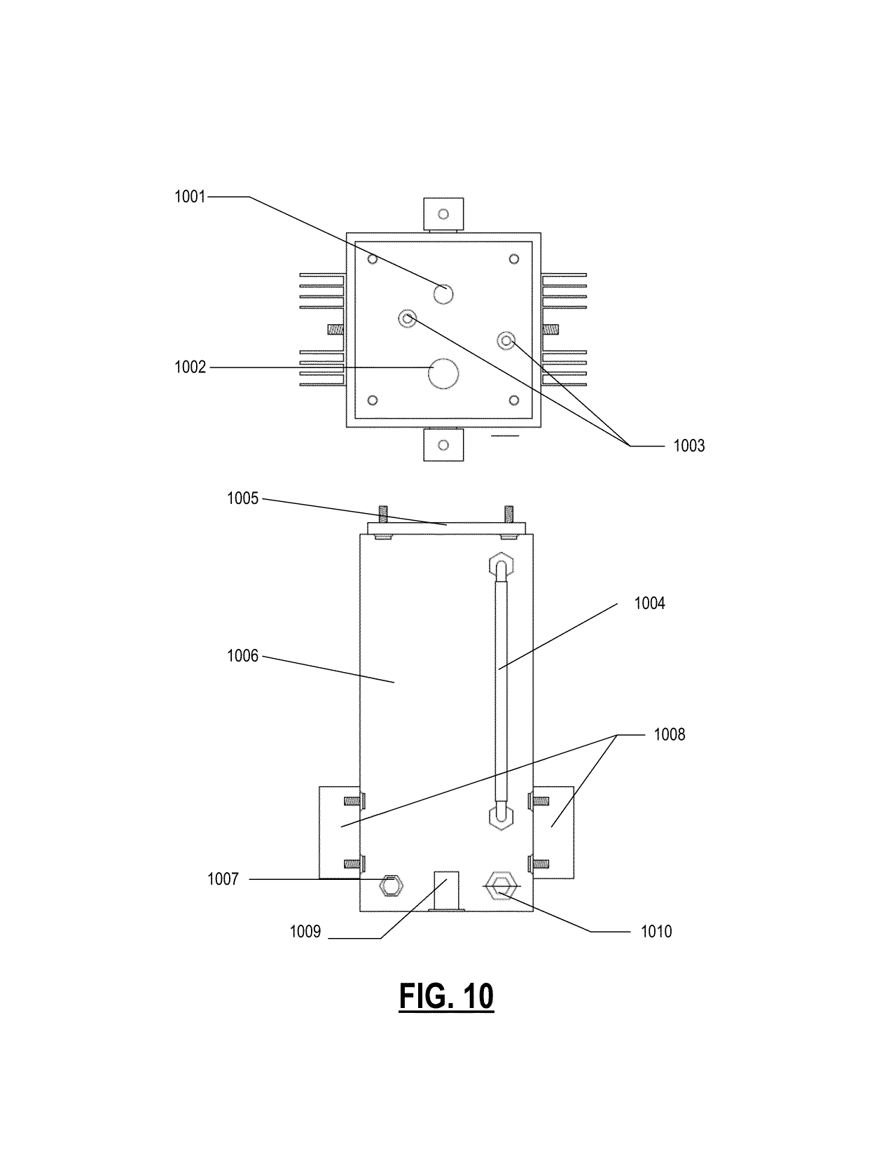

Referring now to FIG. 10, schematic design of a container that may be used to house the concentric coils of FIG. 9 used to generate and provide HHO Gas to the fuel system of a combustion engine in accordance with the present invention is depicted. The exemplary container can include a superior cap or lid 1005 that can serve to seal the stainless steel, metal or plastic container 1006. The cap or lid 1005 can further include an ingress means 1002 for an aqueous solution to be introduced into the container and an egress means 1001 for the HHO Gas. Additionally, the cap or lid may also serve as support for the electrical conductors 1003.

At 1004, a liquid level indicator is depicted to signal when the container needs to be filled with liquid solution. The indicator may signal the need for additional liquid solution through a visual signal, audio signal, etc. At 1008, heat regulators may be included to control the temperature of the container and the surrounding environments and maintain it at an appropriate temperature for the production of HHO Gas. At 1009, the supporting structures for the container are shown. They may be used to fixedly attach the container to a vehicle where desired.

At 1007, a temperature sensor, pressure sensor, and/or pressure valve may be included in the apparatus. Further, the container of the apparatus can also include a fixture 1010 to drain the container when it is desired, for example for cleaning and/or replacement of the liquid electrolyte being used.

### CONCLUSION

A number of embodiments of the present invention have been described. While this specification contains many specific implementation details, there should not be construed as limitations on the scope of any inventions or of what may be claimed, but rather as descriptions of features specific to particular embodiments of the present invention.

Certain features that are described in this specification in the context of separate embodiments can also be implemented in combination in a single embodiment. Conversely, various features that are described in the context of a single embodiment can also be implemented in combination in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while method steps are depicted in the drawings in a particular order, this should not be understood as requiring that such steps be performed in the particular order shown or in sequential order, or that all illustrated operations be performed, to achieve desirable results. In certain circumstances, multitasking and parallel may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed invention.

1. An apparatus for supplying HHO Gas to a combustion engine, the apparatus comprising:
a container for storing a liquid solution and an atmosphere;
an anode positioned in close proximity to an anode; wherein the cathode and the anode are configured in concentric designs making up at least portions of one or more coil(s) within said container;
a source of electrical current is in electrical connection to a conductive material and the conductive material is also in electrical connection with one or more of the anode and the cathode coil(s); wherein the source of electrical current is capable of providing a current to said conductive material and the current is proportional to a HHO Gas generated from the break of molecules in the liquid solution;
a fixture used as a means of egress for transferring a portion of the atmosphere away from the container; and
a structure used to position the contained in a fixed orientation.

2. The apparatus of claim 1, wherein one or both of the anode and the cathode comprise a conductive material.

3. The apparatus of claim 2, wherein the conductive material comprises one or both of: a metallic and a semi-metallic material.

4. The apparatus of claim 2, wherein the conductive material comprises stainless steel.

5. The apparatus of claim 4, wherein the stainless steel comprises 316 L gauge wire.

6. The apparatus of claim 1, wherein the liquid solution comprises an electrolyte.

7. The apparatus of claim 6, wherein the electrolyte comprises sodium bicarbonate.

8. The apparatus of claim 1, wherein liquid solution comprises purified water (H2O) and NaHCO3 with a concentration of about 0.02 mol/lt up to about 0.2 mol/lt L.

9. The apparatus of claim 1, wherein the fixture used as a means of egress for transferring a portion of the atmosphere comprises tubing is in atmospheric communication with an air intake of an engine.

10. The apparatus of claim 9, wherein the engine is an internal combustion engine of a motor vehicle.

11. The apparatus of claim 1, wherein the atmosphere comprises hydrogen and oxygen.

12. The apparatus of claim 1, additionally comprising a temperature sensor.

13. The apparatus of claim 12, wherein the temperature sensor comprises an electrical thermometer capable of delivering a signal upon a measured temperature above a predetermined threshold to adjust current being delivered.

14. The apparatus of claim 13, wherein the temperature sensor is used to maintain a temperature equal to or below 70 Degrees Celsius.

15. The apparatus of claim 1, additionally comprising a pressure valve.

16. The apparatus of claim 1, wherein the container comprises a thermoplastic material.

17. The apparatus of claim 1, wherein the container comprises a metal material.

18. The apparatus of claim 17, wherein the metal material comprises stainless steel.

19. The apparatus of claim 17, wherein the metal material comprises aluminum.

20. The apparatus of claim 1, additionally comprising a means of removing the liquid solution from the container.
